(19) United States
(12) Patent Application Publication
(10) Pub. No.: US 2015/0345421 A1
(43) Pub. Date: Dec. 3, 2015

(54) COMBUSTION-CHAMBER BOWL RIM AND OF A COMBUSTION CHAMBER BOWL BASE OF A PISTON OF AN INTERNAL COMBUSTION ENGINE

(71) Applicant: KS KOLBENSCHMIDT GMBH, Neckarsulm (DE)

(72) Inventor: Volker Gniesmer, Alfeld (DE)

(21) Appl. No.: 14/748,938

(22) Filed: Jun. 24, 2015

Related U.S. Application Data
(63) Continuation of application No. 13/877,778, filed on Jun. 19, 2013.

(30) Foreign Application Priority Data
Oct. 5, 2010 (DE) 102010047359.6

(51) Int. Cl. F02F 3/02; C21D 9/08; C21D 1/06; F02F 3/00

(52) U.S. Cl. CPC F02F 3/02; F02F 3/0069; F02F 3/003; C21D 9/085; C21D 1/06

(57) ABSTRACT

A method for producing a piston of an internal combustion engine and to a piston produced according to the method having a piston crown with annular grooves, a combustion-chamber bowl, and piston shaft having a pin bore for receiving a pin, wherein both a combustion-chamber rim and a combustion-chamber bowl base are melted and thereafter solidified.

### BACKGROUND

The disclosure relates to a piston of an internal combustion engine having a piston crown with annular grooves and, a combustion chamber bowl and a piston skirt with a pin bore to receive a pin and to a method for producing such a piston.

Fundamentally different constructions for pistons for internal combustion engines are known, for example, single-piece pistons, the blank for which is forged or cast in one piece. In addition, finished single-piece pistons in the operating state are known that consist, for example, of an upper part and a lower part, wherein both parts are permanently joined to each other in a suitable joining process. In addition to these pistons, articulated pistons are known in which a piston upper part is connected to a piston skirt part by means of a pin. Common to these pistons, regardless of their construction, is the fact that they have a piston crown with annular grooves and a combustion chamber located in the piston crown. In addition, the ready-to-use piston has a piston skirt, for example, with continuously cylindrical load-bearing piston skirts or with partially load-bearing piston skirt sections, wherein a pin bore is located in the piston skirt in a known way that receives a pin to connect the piston to the connecting rod.

In the aforementioned piston constructions, a combustion chamber bowl is located in the piston crown.

It has been known for several decades in the prior art to remelt the rim of the combustion chamber bowl so that a change in the microstructure takes place as a result and, after the remelted area solidifies, a considerably more hard-wearing area of the combustion chamber bowl rim is available than could be achieved by producing the piston blank through a casting or forging process. There are different methods concerning how the combustion chamber bowl rim can be remelted to increase the desired strength in this rim area of the combustion chamber bowl. Representative of the many years of development in this field, the German examined and published application 1 122 325, German patent application 2 124 595 A1, German utility model GM 80 28 685, DE 199 02 864 A1 and EP 1 386 687 A1 can be named. It is clear from this representative state of the art that there have been decades-long efforts to improve the strength of the combustion chamber bowl rim in the piston crown of the piston of the internal combustion engine, and these efforts continue.

These efforts proceed because, as a result of increased demands on modern internal combustion engines, particularly with regard to reducing fuel consumption while simultaneously reducing exhaust pollutant emissions, combustion pressures have clearly increased. This increase in combustion parameters has led at the same time to a further increase in the load on the combustion chamber bowl, in particular, the combustion chamber bowl rim, so that further development and improvements are required.

It must be pointed out in addition that the combustion chamber bowl rim, just like the combustion chamber bowl base of pistons of internal combustion engines, are particularly stressed areas. Because, as a result of the increased temperature load either in the combustion chamber rim area and/or in the combustion chamber base area, the piston expands more strongly than the adjacent areas lying therebehind (in the case of the combustion chamber bowl rim in a plane parallel to the piston crown, or in the case of the combustion chamber bowl rim, the areas lying below the combustion chamber bowl base with respect to the piston stroke axis). As a result of the colder material lying behind the bowl rim, or below the bowl base, the bowl rim or the bowl base are prevented from expanding while the piston is operating in the internal combustion engine. The result is plastic deformation under severe compression stress. Because of these stresses and also because of malformations in the microstructure of the area under this type of strain, stress is created that in the worst case can result in a fracture or a crack, the consequence of which is piston failure. In order to prevent this plastic deformation under high pressure, measures are known, for example, anodizing the combustion chamber bowl rim or having a fiber-reinforced material applied. However, additional process steps (e.g. anodizing) and additional, somewhat dangerous materials have to be employed so that these measures to minimize stress have so far remained unsatisfactory.

It would, therefore, be desirable to provide a piston with a combustion chamber bowl and a method for producing such a piston that can satisfy the requirements for the piston during internal combustion engine operation better than known pistons in the prior art.

### SUMMARY

In the case of the piston of the internal combustion engine in accordance with the following description, provision is made for both the combustion chamber bowl rim and the combustion chamber bowl base to be formed from a melted and solidified area.

In one aspect of the method for producing a piston, provision is made for both the combustion chamber bowl rim and the combustion chamber bowl base to be melted and subsequently solidify.

The melting and the subsequent solidifying of both the combustion chamber bowl rim and the combustion chamber bowl base has the advantage that the combustion chamber bowl, which is especially stressed as the consequence of the combustion parameters in the internal combustion engine (increased combustion pressures and increased combustion temperatures), is considerably improved with respect to its load capacity compared with pistons in which only the combustion chamber bowl rim is melted and solidified and thus strengthened. As a result of these areas strengthened in accordance with the disclosed method (combustion chamber bowl rim and, at the same time, the combustion chamber bowl base), precisely those areas which are under particular stress/load as a result of the combustion parameters are specifically strengthened so that pistons produced in this way are particularly wear-resistant and can be employed reliably in internal combustion engines that satisfy today's requirements for fuel consumption and pollutant emissions particularly well.

The methods already mentioned in the prior art can be considered for the melting process, in particular electric arc welding, laser beam, electron beam or similar as this list is not exhaustive.

It is additionally conceivable that, before and/or during the melting process, for supplemental heating of the piston to be carried out that is considerably higher than the ambient temperature prevailing during production of the piston (or of the piston blank) to improve still further the microstructure resulting after the piston is treated.

It is equally conceivable that the combustion chamber bowl rim and the combustion chamber bowl base of the piston blank consisting of the same material are melted. As an alternative, it is conceivable that the areas of the combustion chamber bowl rim and of the combustion chamber bowl base consist of different materials (this is particularly the case when the piston consists of an upper part and a lower part that are joined together and the two parts are formed of different materials) or when supplementary materials, such as alloys or the similar, are added during the remelting to the two areas of the rim and the base (consisting of the same material or of different materials).

When further developing the method and resulting piston, provision is made for the combustion chamber bowl rim to be formed from a material with a definable coefficient of thermal expansion and for the material behind the combustion chamber bowl rim to have a higher coefficient of thermal expansion compared with the former. The term “behind” is to be understood to mean that the combustion chamber bowl rim has a specific height relative to the piston stroke axis and that the radially circumferential end areas facing inward form the combustion chamber bowl rim. The combustion chamber bowl rim, in geometric terms, is, virtually, an annular construct, where the construct does not necessarily have to have a circular cross-section. In the plane at the height of the combustion chamber bowl rim there is lying therebehind (facing outward therefore, in the direction of the ring zone) an area that is also formed by the crown of the piston. Here, in accordance with the disclosure, provision is made for the end area of the combustion chamber bowl rim facing in the direction of the combustion chamber bowl to consist of a material that has a definable coefficient of thermal expansion. The combustion chamber bowl rim lying in this plane, aligned parallel to the surface of the piston crown that faces in the direction of the combustion side, is formed of a material that has a greater coefficient of thermal expansion compared with the outward facing material. This means that the combustion chamber bowl rim on which high temperature impinges consists of a first material that purposefully possesses a lower coefficient of thermal expansion than the material behind it that is colder or becoming colder. The material that is becoming colder expands consequently approximately the same as the material that forms the combustion chamber bowl rim. The temperature differences are compensated for by the different coefficients of thermal expansion so that minimization of stress consequently exists in this area. The local difference in materials in the area of the combustion chamber bowl rim can be achieved by local material alloy formation. For example, alloys increasing or reducing the coefficient of thermal expansion can be added to the material that forms the combustion chamber bowl rim. Copper, for example, increases the coefficient of thermal expansion, whereas iron as the alloying element reduces the coefficient of thermal expansion. The admixture can be undertaken through deposition welding, for example.

As an alternative, or as a supplement, to the prior/previous measures, the visible area of the combustion chamber bowl base is formed of a material with a definable coefficient of thermal expansion and the material under the combustion chamber bowl base has a higher coefficient of thermal expansion compared with the combustion chamber bowl base. Here, too, it holds that the material of the combustion chamber bowl base that faces the combustion chamber bowl is subject to higher temperatures than the material of the piston below the combustion chamber bowl base that faces in the direction of the piston pin and in cooling-channel pistons is often additionally cooled by a cooling medium, for example engine oil, injected or sprayed onto this area. As a result of the shaping of the combustion chamber bowl base and of the material lying thereunder (with regard to the piston stroke axis) using different coefficients of thermal expansion, the expansion of these areas is equalized, so that the temperature differences are compensated for by the different coefficients of thermal expansion. In the area of the combustion chamber bowl base, the stresses resulting from the temperature differences are considerably minimized in an advantageous fashion. It must be pointed out that, in employing this measure, a steady and not an abrupt change of material takes place, both in the combustion chamber bowl rim and in the combustion chamber bowl base in the course of the transition between the adjacent materials with different coefficients of thermal expansion, so that, as a result, the temperature differences can be equalized in an additionally further advantageous manner.

In a particularly advantageous manner an energy input is introduced through an energy source for the purpose of melting the combustion chamber bowl rim and the combustion chamber bowl base simultaneously, so that, as a result, the desired remelting and subsequent solidification can be carried out quickly and optimally coordinated, which is of particular advantage in the series production of pistons because cycle times are reduced as a result. The methods mentioned previously of electric arc welding, the application of laser beams, electron beams or similar can be considered as an energy source. Alternatively, thought can be given to first melting the combustion chamber bowl rim and then waiting until the area has solidified before the combustion chamber bowl base is melted and then waiting until this area has solidified. Furthermore, it is ultimately conceivable that, for example, the combustion chamber bowl base is melted first and, while it is still solidifying, the melting of the combustion bowl chamber rim begins. These two steps in the process can be applied in the reverse order. This has the advantage that with the melting of the first area (either combustion chamber bowl rim or combustion chamber bowl base), the second area (either combustion chamber bowl base or combustion chamber bowl rim) is already pre-heated by the input of energy so that it is advantageously superfluous to undertake additional heating of the piston crown.

### BRIEF DESCRIPTION OF THE DRAWING

The various features, advantages and other uses of the present improvements to combustion chamber bowl rim and combustion chamber bowl based of a piston of an internal combustion engine would become more apparent by referring to the following detailed description and drawing in which:

FIG. 1 is a pictorial representation of a internal combustion engine combustion chamber bowl about a piston stroke axis.

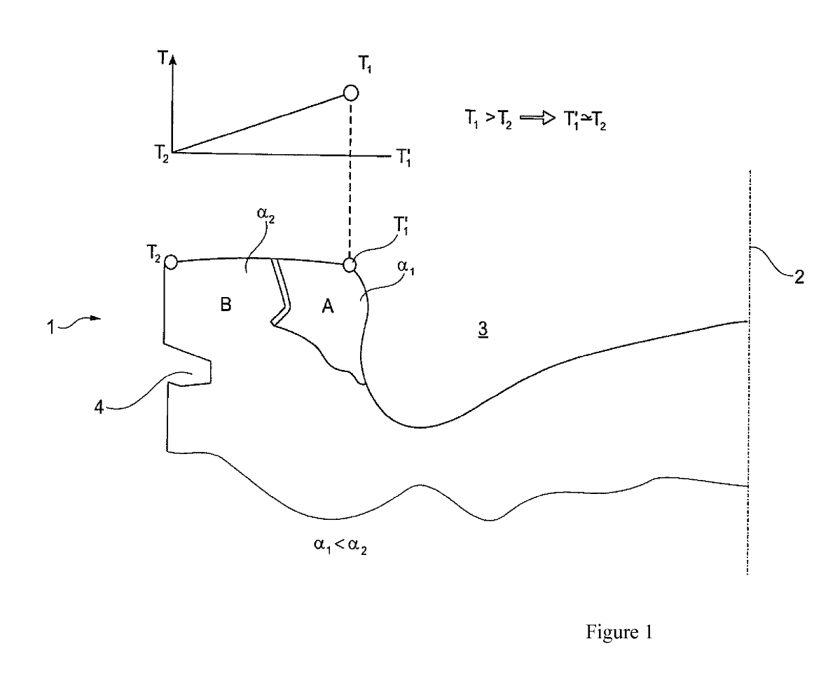

### DETAILED DESCRIPTION

A section of a piston crown 1 of a piston, not shown in greater detail, is shown in the only drawing figure as having a combustion chamber bowl 3 around a piston stroke axis 2. At least one annular groove 4 is present on the outer surface of the piston crown. The measure in accordance with the invention can be recognized by the fact that the combustion chamber bowl rim A has a first coefficient of thermal expansion α1, and the area of the piston crown 1 lying behind the rim A, identified here with B, has a different coefficient of thermal expansion α2, where α1<α2 applies. From this it follows that, regarded over the progression of the area from A to B, the temperature T₁ prevailing in the area of the combustion chamber bowl rim A, which is actually higher than the temperature T₂ prevailing further to the outside, is distinctly lowered to a temperature T₁. The aim is for the temperature profile in the transition of the combustion chamber bowl rim A to the outside to be consistent, i.e. that in the area of the piston crown facing in the direction of the combustion chamber the same or almost the same temperatures, or temperature level prevails.

The same as was described previously regarding conditions at the combustion chamber bowl rim, holds true alternatively or supplementary for the combustion chamber bowl base wherein the temperature profile is to be equalized not perpendicular to the axis of the piston stroke, but following the axis of the piston stroke.

1. A piston of an internal combustion engine having a piston crown with annular grooves, a combustion chamber bowl, and a piston skirt with a pin bore to receive a pin, comprising:
both a combustion chamber bowl rim and a combustion chamber bowl base of the combustion chamber bowl formed by a melted and solidified area containing material from both of the combustion chamber bowl rim and the combustion chamber bowl base.

2. The piston from claim 1, wherein the melted and solidified area is formed of the same metal.

3. The piston from claim 1, wherein the melted and solidified area is formed from different materials.

4. The piston from claim 3, wherein the combustion chamber bowl rim is formed of a material with a definable coefficient of thermal expansion and the material lying behind the combustion chamber bowl rim has a higher coefficient of thermal expansion.

5. The piston from claim 3, wherein the combustion chamber bowl base is formed of a material with a definable coefficient of thermal expansion and wherein the material lying under the combustion chamber bowl base has a higher coefficient of thermal expansion.

6. A method for producing a piston of an internal combustion engine having a piston crown with annular grooves, a combustion chamber bowl, a piston skirt with a pin bore to receive a pin, comprising:
melting and subsequently solidifying both a combustion chamber bowl rim and a combustion chamber bowl base of the combustion chamber bowl to form a melted and solidified area containing material of both the combustion chamber bowl rim and the combustion chamber bowl base.

7. The method from claim 6, wherein the combustion chamber bowl rim and the combustion chamber bowl base are melted by the application of an energy source.

8. The method from claim, 6 wherein the combustion chamber bowl rim and the combustion chamber bowl base are melted in succession by the application of an energy source.

9. The method from claim 6, comprising:
the melted and solidified area of the combustion chamber bowl rim and the combination chamber bowl base formed of the same metal.

10. The method from claim 6 comprising:
the melted and solidified area of the combustion chamber bowl rim and the combustion chamber bowl base formed from different materials.

11. The method of claim 10 further comprising:
forming the combustion chamber bowl rim of a material with a definable coefficient of thermal expansion; and
forming the material lying behind the combustion chamber bowl rim with a higher coefficient of thermal expansion.

12. The method of claim 10 comprising:
forming the combustion chamber bowl base of a material with a definable coefficient of thermal expansion; and
forming the material underlying the combustion chamber bowl base with a higher coefficient thermal expansion.
